(19) United States
(12) Patent Application Publication
(10) Pub. No.: US 2015/0213100 A1
(43) Pub. Date: Jul. 30, 2015

(54) DATA SYNCHRONIZATION METHOD AND SYSTEM

(71) Applicant: TENCENT TECHNOLOGY (SHENZHEN) COMPANY LIMITED, Shenzhen (CN)

(72) Inventors: XINGCAI JIANG, Shenzhen (CN); MING TIAN, Shenzhen (CN); LI LIU, Shenzhen (CN); LIHUA HUANG, Shenzhen (CN); ZHONGWEI LI, Shenzhen (CN)

(73) Assignee: TENCENT TECHNOLOGY (SHENZHEN) COMPANY LIMITED

(21) Appl. No.: 14/682,261

(22) Filed: Apr. 9, 2015

Related U.S. Application Data
(63) Continuation of application No. PCT/CN2013/079087, filed on Jul. 9, 2013.

(30) Foreign Application Priority Data
Oct. 18, 2012 (CN) 2012-10397350.7

(51) Int. Cl. G06F 17/30

(52) U.S. Cl. CPC G06F 17/30575; G06F 17/30132; G06F 17/30191; G06F 17/30371

(57) ABSTRACT

Embodiments of the present invention disclose a data synchronization method and system. Update data from external is written to a first data storage system in a write operation by a first writing module. The write operation is recorded and a binary log (BinLog) is generated according to the update data by a generating module. The BinLog is written separately to a cache pool and a BinLog file in a magnetic disk by a second writing module. When performing synchronization for the update data, the cache pool is searched for the BinLog corresponding to the update data, and the BinLog is sent to a second data storage system for data synchronization by a synchronization module. A synchronization scheme for asynchronous transmission based on a cache pool and a BinLog file is disclosed. A data storage system is separated from a data synchronization system for updating data copies to a latest state.

### CROSS REFERENCE OF RELATED APPLICATION

This application is a continuation of PCT Application No. PCT/CN2013/079087, filed on Jul. 09, 2013, which claims priority to Chinese Patent Application No. 201210397350.7, filed with the Chinese Patent Office on Oct. 18, 2012 and entitled “DATA SYNCHRONIZATION METHOD AND SYSTEM”, all of which are incorporated herein by reference in their entirety.

### FIELD OF THE TECHNOLOGY

The present disclosure generally relates to the field of data storage and transmission technologies, and in particular, relates to a data synchronization method and system.

### BACKGROUND OF THE DISCLOSURE

User generated content (UGC) is a new manner in which a user uses the Internet. That is, an original manner in which downloading predominates is changed to a manner in which downloading and uploading are of equal importance. Community network, video sharing, and blog are all main application forms of the UGC. With the continuous development of global Internet services, a UGC service is increasingly rising, and attracts extensive attention from the industry.

For secure operation, a disaster recovery solution is introduced during system design. The disaster recovery solution requires a system to have at least two available complete data copies. The data copies are independently deployed, and both can provide a full real-time service. When an exception or a disaster occurs to one of the data copies, which fails to provide a normal service, a request may be switched for another available data point, to provide an uninterrupted real-time service. How to keep data consistency between the data copies is a difficult problem faced by the disaster recovery solution. If a simple, highly efficient, and low-cost disaster recovery model is available, significant revolution will be brought to the art.

In the existing technology, a data storage system is responsible for data storage, provides a read/write service, and provides a data synchronization service. After one write operation of a user arrives at a service process, the service process firstly queries for how many available data copies in total are in the system. Assuming that there are N available data copies, then the service process replicates the write operation for N copies, and separately sends the write operation to each data copy, so that data in each data copy can be updated to a latest state.

However, problems arise in conventional disaster recovery solutions. (1) Coupling ability or dependency between the data storage system and a data synchronization system is too high. Data storage depends on whether data synchronization is successful. If a write operation succeeds at a main write point, but another data copy fails to be updated, this write operation for all data copies is considered as unsuccessful. (2) The system design is complex. The two systems are equally important, to ensure an outward normal service. When an exception occurs on one system, a normal service in the other system is affected. This design directly increases the operation and maintenance costs. (3) It is difficult to construct a new data copy. When a new data copy needs to be constructed, original historical data needs to be imported, and the system needs to support a write stop. (4) More data copies indicate poorer performance. When there are more available data copies, an update failure of a data copy causes more write operations to be determined as ineffective, which reduces the system performance.

Therefore, there is a need to solve these and other technical problems in the data storage and transmission technologies to provide methods and systems for data synchronization.

### SUMMARY

Embodiments of the present invention provide methods and systems for data synchronization, so as to reduce the overall complexity and coupling of a system, and to provide a highly-reliable and highly-available data synchronization service. The technical solutions are as follows.

Embodiments of the present disclosure provide a method for data synchronization including: writing update data from external to a first data storage system in a write operation by a first writing module of a data synchronization system; recording the write operation and generating a binary log (BinLog) according to the update data by a generating module of the data synchronization system; writing the BinLog separately to a cache pool and a BinLog file in a magnetic disk by a second writing module of the data synchronization system; and searching, when performing synchronization for the update data, the cache pool for the BinLog corresponding to the update data, and sending the BinLog to a second data storage system for data synchronization by a synchronization module of the data synchronization system.

Embodiments of the present invention further provide a method for data synchronization, a system for data synchronization, and a non-transitory computer readable storage medium. The technical solutions are as follows.

A method for data synchronization is provided including: generating a BinLog according to a data write operation performed in a first data storage system; writing the BinLog to a storage device; and independently from the generating of the BinLog and the writing of the BinLog to a storage device, searching BinLogs written in the storage device for a BinLog corresponding to a latest write operation, and sending the BinLog corresponding to the latest write operation to a second data storage system, so that the second data storage system synchronously updates data in the second data storage system according to the BinLog corresponding to the latest write operation.

A system for data synchronization includes a first data storage system and a data synchronization system. The first data storage system is configured to generate a BinLog according to a data write operation performed in the first data storage system and to write the BinLog to a storage device. The data synchronization system is configured to: search, independently from the first data storage system, BinLogs written in the storage device for a BinLog corresponding to a latest write operation, and send the BinLog corresponding to the latest write operation to a second data storage system, so that the second data storage system synchronously updates data in the second data storage system according to the BinLog corresponding to the latest write operation.

According to an embodiment of the present invention, a non-transitory computer readable medium including executable program stored thereon is provided. When being executed, the executable program causes one or more processors of a computing device to implement a data synchronization method to perform: generating a binary log (BinLog) according to a data write operation performed in a first data storage system; writing the BinLog to a storage device; and independent from the generating of the BinLog and the writing of the BinLog to the storage device, searching BinLogs written in the storage device for a BinLog corresponding to a latest write operation, and sending the BinLog corresponding to the latest write operation to a second data storage system, so that the second data storage system synchronously updates data in the second data storage system according to the BinLog corresponding to the latest write operation.

Embodiments of the present invention further provide a disaster recovery system, including a first data storage system, a data synchronization system, and a second data storage system. The first data storage system is configured to generate a BinLog according to a data write operation performed in the first data storage system and to write the BinLog to a storage device.The data synchronization system is configured to: independently from the first data storage system, search BinLogs written in the storage device for a BinLog corresponding to a latest write operation, and send the BinLog corresponding to the latest write operation to the second data storage system. The second data storage system is configured to synchronously update data in the second data storage system according to the BinLog corresponding to the latest write operation.

Embodiments of the present invention further provide another disaster recovery system, including multiple systems for data synchronization, each system for data synchronization including a data storage system and a data synchronization system. The data storage system in a first system for data synchronization is configured to: generate, when a data write operation is performed in the data storage system, a binary log (BinLog) according to the data write operation, and write the BinLog to a storage device, and to synchronously update data in the data storage system in the first system according to a BinLog corresponding to a latest write operation while in a second system for data synchronization, a data write operation is performed in a data storage system of the second system for data synchronization. The data synchronization system in the first system for data synchronization is configured to: when the data write operation is performed in the data storage system, search independently from the data storage system BinLogs written in the storage device for the BinLog corresponding to the latest write operation, and send the BinLog corresponding to the latest write operation to a data storage system of the second system for data synchronization.

Beneficial effects brought by the technical solutions provided by the embodiments of the present invention may include the following. A synchronization scheme for asynchronous transmission based on a cache pool and a BinLog file is provided. A data storage system is separated from a data synchronization system. The data synchronization system is responsible for copying data and updating the data to a latest state according to a BinLog. In this mode, while the system service performance is not reduced at all, the overall complexity, coupling, and bandwidth costs of a system are greatly reduced.

Other aspects or embodiments of the present disclosure can be understood by those skilled in the art in light of the description, the claims, and the drawings of the present disclosure.

### BRIEF DESCRIPTION OF THE DRAWINGS

To describe the technical solutions in the embodiments of the present invention more clearly, the following briefly introduces the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a flowchart of an exemplary data synchronization method according to an exemplary embodiment of the present invention;

FIG. 2 is a connection relationship diagram of a system architecture in an exemplary data synchronization method according to an embodiment of the present invention;

FIG. 3 is a composition diagram of an exemplary data synchronization system according to an embodiment of the present invention;

FIG. 4 is a flowchart of an exemplary method for data synchronization according to an embodiment of the present invention;

FIG. 5 is a block diagram of an exemplary system for data synchronization according to an embodiment of the present invention;

FIG. 6 is a block diagram of a disaster recovery system according to an embodiment of the present invention; and

FIG. 7 illustrates an exemplary computing device consistent with the disclosed embodiments.

### DESCRIPTION OF EMBODIMENTS

Reference will now be made in detail to exemplary embodiments of the disclosure, which are illustrated in the accompanying drawings. Wherever possible, the same reference numbers will be used throughout the drawings to refer to the same or like parts. Embodiments of the present invention provide a data synchronization method and system. In order to make objectives, technical solutions and advantages of the present disclosure clearer, the embodiments of the present invention are described in detail in the following with reference to accompanying drawings.

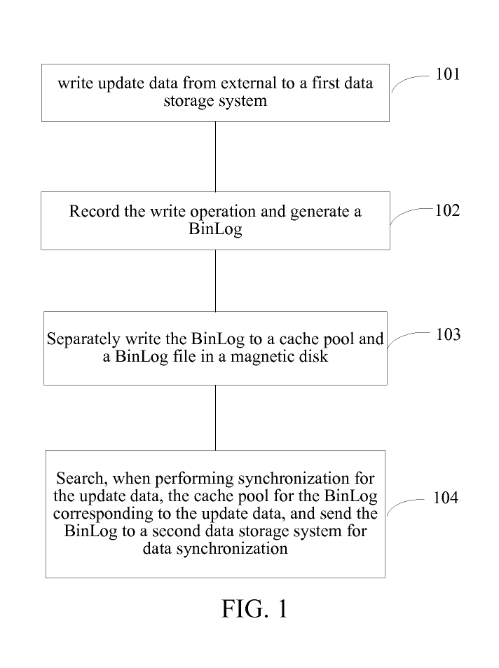

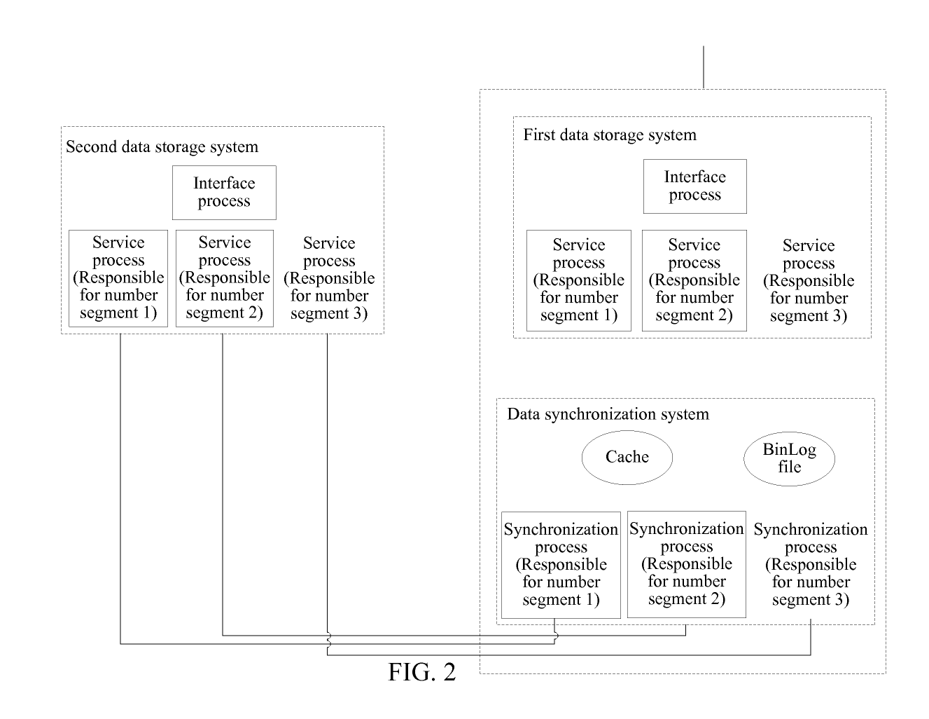

FIG. 1 is a flowchart of an exemplary data synchronization method according to an embodiment of the present invention. FIG. 2 is a connection relationship diagram of exemplary system architecture in a data synchronization method according to an embodiment of the present invention. Referring to both FIG. 1 and FIG. 2, the disclosed method includes the following.

Step S101: includes writing update data from external to a first data storage system in a write operation.

When a user performs a write operation, a service process writes update data of the user to the first data storage system. The service process is a module that provides the user with services such as data read and write, and there may be multiple service processes, and respectively correspond to services within different number-segment ranges, where a number-segment is a range of consecutive IDs, and is a basic unit of deployment or migration, for example, every one hundred thousand consecutive IDs form one deployment number-segment.

Step S102: includes recording the write operation and generate a BinLog according to the updated data.

After successfully writing the update data of the user to the first data storage system, the service process records this write operation and generates a BinLog, where the BinLog records some basic information of this write operation, for example, a write time, a write operation sequence number, and write operation content.

Step S103: includes writing the BinLog separately to a cache pool and a BinLog file in a magnetic disk.

One cache pool is set in the first data storage system, and the cache pool is implemented by using shared internal storage device, and is configured to store a BinLog of a write operation of a user. After writing the external update data to the first data storage system, the service process writes the BinLog that records this write operation to the cache pool. The cache pool is responsible for storing BinLogs within a recent period, and when the cache pool is full, an earliest stored BinLog is automatically deleted.

A BinLog file is further established in the magnetic disk of the first data storage system, and is used to store a BinLog of a write operation of a user. After writing the BinLog to the cache pool, the service process further writes the BinLog to the BinLog file in the magnetic disk, and then returns a result indicating that this write operation is successfully performed to the external. The number of BinLogs that can be written to one BinLog file may be set by the system, for example, one hundred thousand BinLogs can be written to one BinLog file. When one BinLog file is fully written with one hundred thousand BinLogs, a new BinLog file is established for a new BinLog to be written to. Therefore, besides being written to the cache pool, the BinLog is also written to the BinLog file in the magnetic disk; because there is a time limit for a BinLog to be stored to the cache pool, when a new BinLog is written to the cache pool, a BinLog that is earliest stored to the cache pool is automatically deleted, and the BinLog is written to the BinLog file in the magnetic disk, so that the BinLog is saved; in this way, even if a machine is suddenly powdered off and restarted and accordingly data in the cache pool is lost, or the machine suddenly encounters massive write operations so that the BinLog that is earliest written to the cache pool is automatically deleted before synchronization, the BinLog can still be found in the BinLog file in the magnetic disk, to ensure that subsequently a synchronization system can obtain needed synchronization data by reading.

Step S104: includes searching, when performing synchronization for the update data, the cache pool for the BinLog corresponding to the update data, and sending the BinLog to a second data storage system for the data synchronization.

Data synchronization is completed by a synchronization process in a data synchronization system, the synchronization process and the service process run asynchronously, the synchronization process is a module that is responsible for data synchronization, and a number-segment that the synchronization process is responsible for may be consistent with a number-segment that the service process is responsible for.

When external update data is written to the first data storage system, and the synchronization process detects that a data copy (for example, a data copy in the second data storage system) is not in a latest data state, the synchronization process needs to perform data synchronization. When performing synchronization for the update data, the synchronization process searches the cache pool for BinLogs corresponding to the update data for which synchronization needs to be performed, and sends these BinLogs in sequence to the data copy for data synchronization, so that all data copies (for example, data copies in the first and second data storage system) are in a latest data state. During the data synchronization, one BinLog may be sent at one time, and multiple BinLogs may also be sent at one time.

Only BinLogs within a recent period are kept in the cache pool, and therefore when the BinLog corresponding to the update data for which synchronization needs to be performed is not found in the cache pool, the method further includes: further searching, by the synchronization process, the BinLog file saved in the magnetic disk for the BinLog corresponding to the update data, and sending the BinLog to the second data storage system, to complete the synchronization action.

When the synchronization process performs data synchronization, the service process provides a read/write service outward, and the synchronization process and the service process are independent from each other.

If the BinLog file in the magnetic disk is abnormally lost due to an abnormal reason, for example, the BinLog file is deleted by mistake, or the file is lost because the system is faulty, the method further includes: separately regenerating a BinLog by using update data covered in the BinLog file in the first data storage system, and writing the regenerated BinLog to a new BinLog file.

In the foregoing embodiment, a synchronization scheme for asynchronous transmission based on a cache pool and a BinLog file is provided, a data storage system is separated from a data synchronization system, a first data storage system is only responsible for a basic logic for writing of a service, but does not care about a data state of a data copy in another data storage system, and the data synchronization system is responsible for updating data copies to a latest state; in this mode, while the system service performance is not reduced at all, the overall complexity, coupling, and bandwidth costs of a system are greatly reduced.

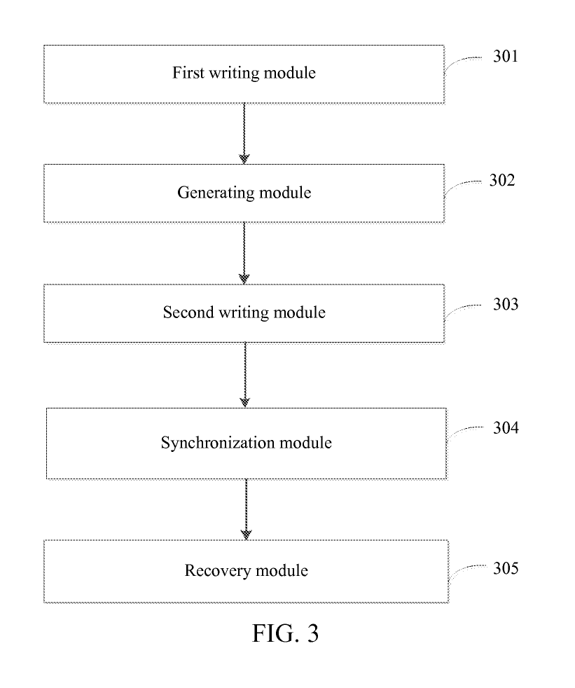

FIG. 3 is a composition diagram of an exemplary data synchronization system according to an embodiment of the present invention. The system includes: a first writing module 301, configured to write update data from external to a first data storage system by a write operation; a generating module 302, configured to record the write operation and generate a BinLog; a second writing module 303, configured to separately write the BinLog to a cache pool and a BinLog file in a magnetic disk; and/or a synchronization module 304, configured to search, when performing synchronization for the update data, the cache pool for the BinLog corresponding to the update data, and send the BinLog to a second data storage system for data synchronization.

The cache pool is responsible for storing BinLogs within a recent period, and the second writing module 303 is further configured to: when the cache pool is full, automatically delete an earliest stored BinLog.

The second writing module 303 first writes the BinLog to the cache pool, then writes the BinLog to the BinLog file in the magnetic disk, and then returns a result indicating that this write operation is successfully performed to the external.

When the synchronization module 304 performs data synchronization, when the BinLog corresponding to the update data for which synchronization needs to be performed is not found in the cache pool, the synchronization module 304 further searches the BinLog file saved in the magnetic disk for the BinLog corresponding to the update data, and sends the BinLog to the second data storage system for data synchronization.

Further, the system further includes a recovery module 305, configured to: when the BinLog file in the magnetic disk is abnormally lost, separately regenerate a BinLog by using update data covered in the BinLog file in the first data storage system, and write the regenerated BinLog to a new BinLog file.

For further details about the data synchronization system in this embodiment, reference may further be made to the disclosed data synchronization method and relevant description in the foregoing embodiment.

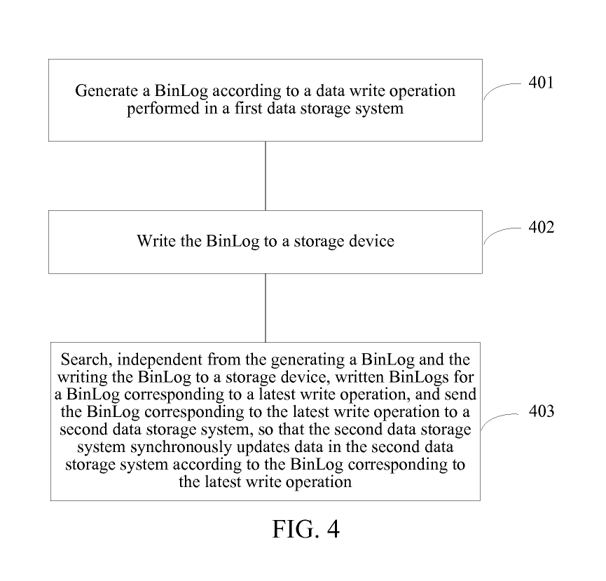

FIG. 4 shows a flowchart of a method for data synchronization according to a preferred embodiment of the present invention. As shown in FIG. 4, the method for data synchronization may include step 401, step 402, and/or step 403.

Step 401: includes generating a BinLog according to a data write operation performed in a first data storage system.

Step 402: includes writing the BinLog to a storage device.

Step 403: includes, independently from the generating of the BinLog and the writing of the BinLog to a storage device, searching BinLogs written in the storage device for a BinLog corresponding to a latest write operation, and sending the BinLog corresponding to the latest write operation to a second data storage system, so that the second data storage system synchronously updates data in the second data storage system according to the BinLog corresponding to the latest write operation.

An external computing device performs the data write operation on the first data storage system. After the data write operation is successfully performed, the BinLog is generated according to the data write operation. The BinLog is written to the storage device. The foregoing procedure may be implemented by one or more service processes. Then, written BinLogs are searched for a BinLog corresponding to a latest write operation, and the BinLog corresponding to the latest write operation is sent to the second data storage system. This procedure may be implemented by using one or more synchronization processes that are respectively corresponding to the service processes.

Steps 401 and 402 are separated from and mutually independent from step 403. In other words, whether step 403 is completed or not does not need to be considered for steps 401 and 402, that is, steps 401 and 402 can be performed again without a need to wait for step 403 to be completed. Therefore, in the method for data synchronization, the complexity and coupling of the method are conspicuously reduced while successful synchronization between multiple data storage systems is ensured, and the bandwidth costs required for synchronization performed between the multiple data storage systems are also greatly reduced.

A BinLog can be used to recover a data write operation. According to a preferred embodiment of the present invention, the method may further include simulating, when the data in the first data storage system is lost, the write operation according to the BinLog written in the storage device to recover the lost data. Specifically, a write operation corresponding to lost data is firstly determined according to existing data in the first data storage system. The storage device is searched for a written BinLog according to the write operation corresponding to the lost data. The write operation is simulated according to the written BinLog to recover the lost data. The security of the first data storage system is effectively ensured by performing the foregoing operations.

According to a preferred embodiment of the present invention, the storage device may include a cache pool. Preferably, the cache pool may be implemented by using internal storage device. For example, in the first data storage system, partial storage space in the internal storage device may be used as the cache pool. After writing the external update data to the first data storage system, the service process writes the BinLog that records this write operation to the cache pool. Implementing the cache pool by using the internal storage device is easy, and can conspicuously increase the access rate.

A capacity of the cache pool is limited. According to a preferred embodiment of the present invention, the writing of the BinLog to a storage device includes: replacing, in the cache pool, an earliest written BinLog with a currently to-be-written BinLog when the cache pool is fully written. The implementation is easy as a first-in first-out mechanism is used.

According to a preferred embodiment of the present invention, the storage device may include a magnetic disk. The magnetic disk is generally a non-volatile storage device. When the first data storage system is suddenly powered off, data stored in the magnetic disk will not be lost, thereby ensuring the security of a BinLog.

Preferably, the writing of the BinLog to a storage device includes: writing the BinLog to a BinLog file in the magnetic disk, where each BinLog file can include a preset number of BinLogs. Each BinLog may have a unique sequence number. In this way, the system can highly effectively manage a BinLog by using the magnetic disk.

According to a preferred embodiment of the present invention, the writing of the BinLog to a storage device includes writing the BinLog to a cache pool and a magnetic disk. The searching of BinLogs written in the storage device for a BinLog corresponding to a latest write operation includes searching the cache pool for the BinLog corresponding to the latest write operation. The searching of written BinLogs for a BinLog corresponding to a latest write operation further includes searching the magnetic disk for the BinLog corresponding to the latest write operation when the BinLog corresponding to the latest write operation cannot be found in the cache pool.

According to a preferred embodiment of the present invention, after a BinLog is written to a cache pool, the BinLog is further written to a BinLog file saved in a magnetic disk. Specifically, in one aspect, writing of the BinLog to the cache pool can ensure that a synchronization process can quickly find the BinLog from the cache pool. In another aspect, it can be ensured that, when the synchronization process does not find the written BinLog from the cache pool, for example, the BinLog to be searched for has been replaced with a BinLog that is later written, the synchronization process can find the written BinLog in the BinLog file saved in the magnetic disk. In this way, it is ensured that the data synchronization system can obtain a needed/desired BinLog by reading.

According to an embodiment of the present invention, the method for data synchronization of the present disclosure further includes: comparing the number of the written BinLogs with the number of times of synchronously updating data in the second data storage system. When the number of the written BinLogs is greater than the number of times of synchronously updating data in the second data storage system, the searching of written BinLogs for a BinLog corresponding to a latest write operation, and the sending of the BinLog corresponding to the latest write operation to a second data storage system is performed.

For example, in an embodiment, the number of written BinLogs is 6, and the number of times of synchronously updating data in the second data storage system is 4. Because 6 is greater than 4, written BinLogs in the storage device are searched for a BinLog corresponding to a latest write operation (that is, the fifth and sixth BinLogs), and the BinLog corresponding to the latest write operation is sent to the second data storage system, so that the second data storage system synchronously updates data in the second data storage system according to the BinLog corresponding to the latest write operation.

The foregoing method for detecting a data state in the second data storage system has strong operability. According to an embodiment of the present invention, the method may further include: returning, after the BinLog is written to the storage device, a message indicating that the write operation is successfully performed to a computing device that performs the write operation. In this way, the computing device can perform a new write operation in time. As described above, steps 401 and 402 and step 403 are mutually independent. Therefore, as long as the BinLog is written to the storage device, it can be considered that the write operation has succeeded. No matter whether data in another data storage system except the first data storage system is updated or not, the new write operation can continue to be performed on the first data storage system.

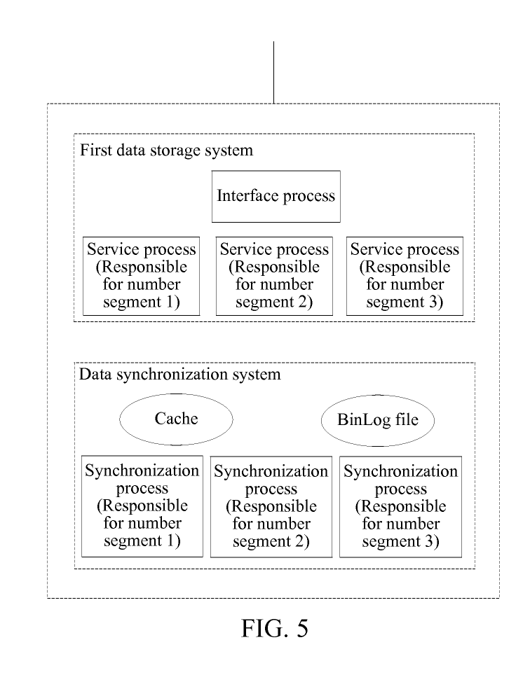

According to another aspect of the present disclosure, a system for data synchronization is further provided. FIG. 5 is a block diagram of a system for data synchronization according to an embodiment of the present invention. As shown in FIG. 5, the system includes a first data storage system and a data synchronization system.

The first data storage system is configured to generate a BinLog according to a data write operation performed in the first data storage system and write the BinLog to a storage device. In FIG. 5, the storage device is shown as a cache pool and a BinLog file in a magnetic disk. The data synchronization system is configured to: search, independently from the first data storage system, BinLogs written in the first data storage system for a BinLog corresponding to a latest write operation, and send the BinLog corresponding to the latest write operation to a second data storage system, so that the second data storage system synchronously updates data in the second data storage system according to the BinLog corresponding to the latest write operation.

Preferably, the first data storage system is further configured to return, after the BinLog is written to the storage device, a message indicating that the write operation is successfully performed to a computing device that performs the write operation.

Preferably, the data synchronization system is further configured to simulate, when the data in the first data storage system is lost, the write operation according to the written BinLog to recover the lost data.

By referring to the method for data synchronization that is described above in detail, a person of ordinary skill in the art may understand the specific operations of the system for data synchronization. For brevity, details are not provided again herein.

According to an embodiment of the present invention, a non-transitory computer readable medium including executable program stored thereon is provided. When being executed, the executable program causes one or more processors of a computing device to implement a data synchronization method to perform: generating a binary log (BinLog) according to a data write operation performed in a first data storage system; writing the BinLog to a storage device; and independent from the generating of the BinLog and the writing of the BinLog to the storage device, searching BinLogs written in the storage device for a BinLog corresponding to a latest write operation, and sending the BinLog corresponding to the latest write operation to a second data storage system, so that the second data storage system synchronously updates data in the second data storage system according to the BinLog corresponding to the latest write operation.

In various embodiments, the executable program is further capable of being operated to: implement all the steps of the method for data synchronization. For brevity, an additional function of the executable program is not further described herein. It should be noted that, the code may directly make a processor of a computing device implement a specified operation, may be compiled to make the processor implement the specified operation, and/or may be combined with other software, hardware, and/or a firmware component (for example, a library for implementing a standard function) to make the processor implement the specified operation.

According to another aspect of the present disclosure, a disaster recovery system is further provided, as shown in FIG. 2. The system includes a first data storage system, a data synchronization system, and a second data storage system.

The first data storage system is configured to generate a BinLog according to a data write operation performed in the first data storage system and write the BinLog to a storage device. Then, the data synchronization system is configured to: search, independently from the first data storage system, BinLogs written in the first data storage system for a BinLog corresponding to a latest write operation, and send the BinLog corresponding to the latest write operation to the second data storage system. The second data storage system is configured to synchronously update data in the second data storage system according to the BinLog corresponding to the latest write operation.

According to a preferred embodiment of the present invention, the first data storage system and the data synchronization system are implemented by using a same computing device.

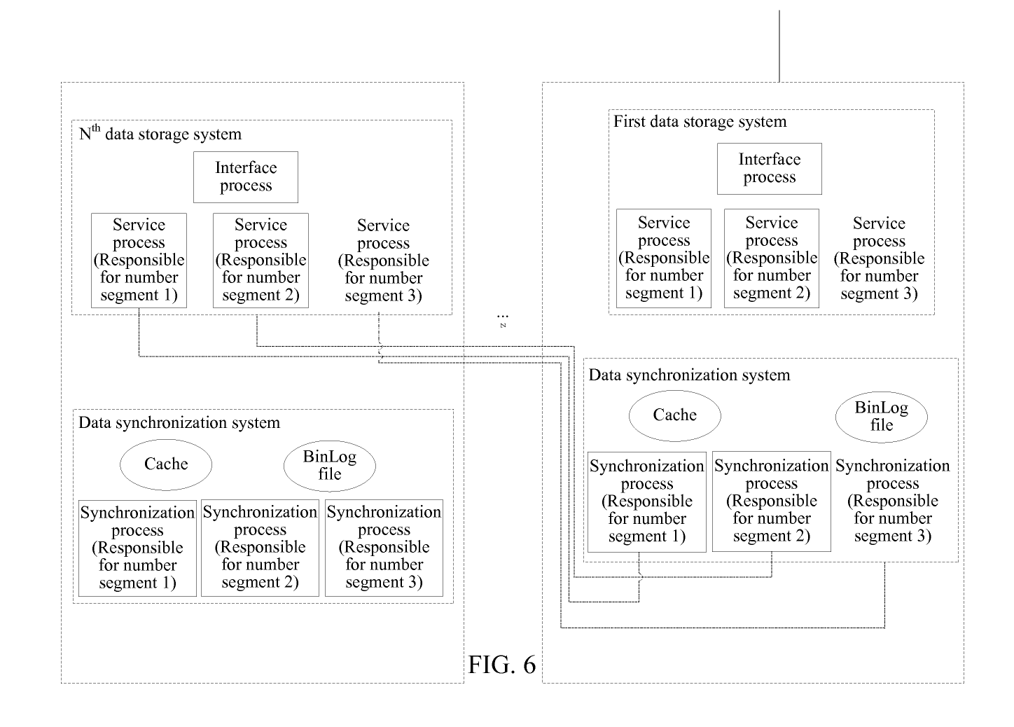

FIG. 6 is a block diagram of a disaster recovery system according to another embodiment of the present invention. The disaster recovery system includes multiple systems for data synchronization. Each system for data synchronization includes a data storage system and a data synchronization system.

The data storage system is configured to generate, when a data write operation is performed in the data storage system, a BinLog according to the write operation, and write the BinLog to a storage device. The data storage system is further configured to synchronously update, when a data write operation is performed in a data storage system of another system for data synchronization, data in the data storage system according to a BinLog thereof corresponding to a latest write operation.

The data synchronization system is configured to: when a data write operation is performed in the data storage system, search, independently from the data storage system, BinLogs written in the data storage system for a BinLog corresponding to a latest write operation, and send the BinLog corresponding to the latest write operation to a data storage system of another system for data synchronization.

By referring to the method for data synchronization that is described above in detail, a person of ordinary skill in the art may understand the specific operations of the disaster recovery system. For brevity, details are not provided again herein.

In the disaster recovery system, each system for data synchronization includes a data storage system and a data synchronization system. Therefore, each system for data synchronization may be configured to receive external update data. Therefore, when a current system for data synchronization that is configured to receive external update data is faulty, another system for data synchronization may be configured to replace the current system for data synchronization to receive external update data. In this way, the disaster recovery system keeps running normally.

The data synchronization method and system that are provided in the foregoing embodiments have the following advantages. For example, a synchronization process and a service process may work asynchronously, which reduces coupling there-between. Two systems can be independently designed, developed, put online, and maintained; the designs are simple, and the operation and maintenance costs are low, which improves the synchronization success rate. A result indicating that a write operation of a user is successfully performed can be returned outward as long as a BinLog is successfully written. Introduction of a cache pool greatly reduces the number of times of reading a magnetic disk by a synchronization process, which improves the performance of an entire system. A BinLog file ensures that any synchronization data can be found, and when a data copy is newly constructed, synchronization may be performed by using a BinLog, to update the new data copy to a latest state without a need to stop a write service.

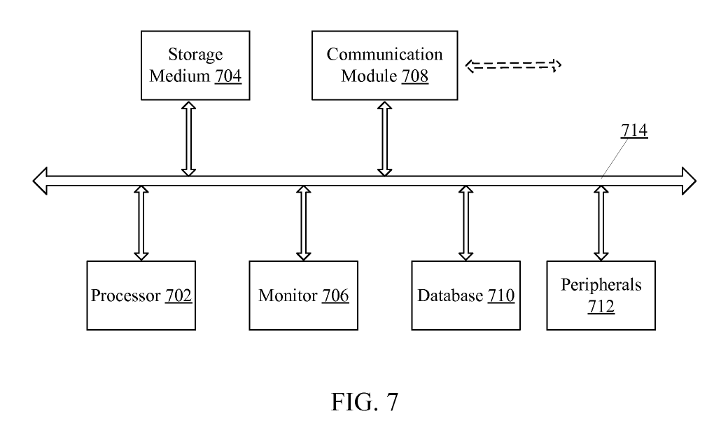

For example, FIG. 7 illustrates an exemplary computing device capable of implementing the disclosed methods involving the data storage system(s) and the data synchronization system consistent with the disclosed embodiments.

As shown in FIG. 7, the exemplary computing device 700 may include a processor 702, a storage medium 704, a monitor 706, a communication module 708, a database 710, peripherals 712, and one or more bus 714 to couple the devices together. Certain devices may be omitted and other devices may be included.

Processor 702 may include any appropriate processor or processors. Further, processor 702 may include multiple cores for multi-thread or parallel processing. The processor 702 may be used to run computer program(s) stored in the storage medium 704. Storage medium 704 may include memory modules, such as ROM, RAM, and flash memory modules, and mass storages, such as CD-ROM, U-disk, removable hard disk, etc. Storage medium 704 may store computer programs for implementing various disclosed methods (e.g., methods for updating IP geographic information), when executed by processor 702. In one embodiment, storage medium 704 may be a non-transitory computer-readable storage medium having a computer program stored thereon, when being executed, to cause the computer to implement the disclosed methods.

Further, peripherals 712 may include I/O devices such as keyboard and mouse, and communication module 708 may include network devices for establishing connections, e.g., through a communication network such as the Internet. Database 710 may include one or more databases for storing certain data and for performing certain operations on the stored data, such as webpage browsing, database searching, etc.

In various embodiments, the computing device may be a personal computer (PC), a work station computer, a server computer, a hand-held computing device (tablet), a smart phone or mobile phone, a car-carrying device, or any other suitable computing device.

It should be further noted that, in this document, the terms “include”, “comprise”, and any variants thereof are intended to cover a non-exclusive inclusion. Therefore, in the context of a process, method, object, or device that includes a series of elements, the process, method, object, or device not only includes such elements, but also includes other elements not specified expressly, or may include inherent elements of the process, method, object, or device. Unless otherwise specified, an element limited by “include a/an . . . ” does not exclude other same elements existing in the process, the method, the article, or the device that includes the element.

A person of ordinary skill in the art may understand that all or some of the processes of the method embodiments may be implemented by a computer program instructing relevant hardware. The program may be stored in a computer readable storage medium. When the program runs, the processes of the method embodiments are performed. The storage medium may be a magnetic disk, an optical disc, a read-only storage device (ROM), or a random access storage device (RAM).

The foregoing descriptions are merely preferred embodiments of the present invention, but are not intended to limit the present disclosure. Any modification, equivalent replacement, or improvement made within the spirit and principle of the present disclosure shall fall within the protection scope of the present disclosure.

What is claimed is:

1. A method for data synchronization, comprising:
writing, by a first writing module of a data synchronization system, update data from external to a first data storage system in a write operation;
recording, by a generating module of the data synchronization system, the write operation and generating a binary log (BinLog) according to the update data;
writing, by a second writing module of the data synchronization system, the BinLog separately to a cache pool and to a BinLog file in a magnetic disk; and
searching, when performing synchronization for the update data, by a synchronization module of the data synchronization system, the cache pool for the BinLog corresponding to the update data, and sending the BinLog to a second data storage system for the data synchronization.

2. The method according to claim 1, further comprising:
automatically deleting an earliest stored BinLog, when the cache pool is stored fully with BinLogs.

3. The method according to claim 1, wherein the BinLog is first written to the cache pool, and then written to the BinLog file in the magnetic disk.

4. The method according to claim 1, wherein, when the BinLog corresponding to the update data for which synchronization needs to be performed is not found in the cache pool, the method further comprises:
further searching the BinLog file stored in the magnetic disk for the BinLog corresponding to the update data, and sending the BinLog to the second data storage system for the data synchronization.

5. The method according to claim 4, wherein, when the BinLog file in the magnetic disk is abnormally lost, the method further comprises:
separately regenerating a BinLog based on update data covered by the BinLog file in the first data storage system, and writing the regenerated BinLog to another BinLog file.

6. A method for data synchronization, comprising:
generating a binary log (BinLog) according to a data write operation performed in a first data storage system;
writing the BinLog to a storage device; and
independently from the generating of the BinLog and the writing of the BinLog to the storage device, searching BinLogs written in the storage device for a BinLog corresponding to a latest write operation, and sending the BinLog corresponding to the latest write operation to a second data storage system, so that the second data storage system synchronously updates data in the second data storage system according to the BinLog corresponding to the latest write operation.

7. The method according to claim 6, further comprising:
simulating, when the data in the first data storage system is lost, the data write operation according to the BinLog written in the storage device to recover the lost data.

8. The method according to claim 6, wherein the storage device comprises a cache pool, and wherein the cache pool is implemented by using internal storage device.

9. The method according to claim 8, wherein the step of writing the BinLog to the storage device comprises:
replacing, in the cache pool, an earliest written BinLog with a currently to-be-written BinLog when the cache pool is fully written.

10. The method according to claim 6, wherein the storage device comprises a magnetic disk.

11. The method according to claim 10, wherein the step of writing the BinLog to the storage device comprises:
writing the BinLog to a BinLog file in the magnetic disk, wherein each BinLog file contains a preset number of BinLogs.

12. The method according to claim 6, wherein
the step of writing the BinLog to the storage device comprises:
writing the BinLog to a cache pool and a magnetic disk; and
the step of searching the BinLogs written in the storage device for the BinLog corresponding to the latest write operation comprises:
searching the cache pool for the BinLog corresponding to the latest write operation; and
searching the magnetic disk for the BinLog corresponding to the latest write operation when the BinLog corresponding to the latest write operation is not found in the cache pool.

13. The method according to claim 6, further comprising:
comparing a number of the BinLogs written in the storage device with a number of times of synchronously updating data in the second data storage system,
wherein, when the number of the written BinLogs is greater than the number of times of synchronously updating data in the second data storage system, the steps of searching BinLogs for the BinLog corresponding to the latest write operation, and sending the BinLog corresponding to the latest write operation to the second data storage system are performed.

14. The method according to claim 6, further comprising:
returning, after the BinLog is written to the storage device, a message indicating that the write operation is successfully performed to a computing device that performs the write operation.

15. A system for data synchronization, comprising:
a first data storage system; and a data synchronization system,
the first data storage system being configured to generate a binary log (BinLog) according to a data write operation performed in the first data storage system and to write the BinLog to a storage device; and
the data synchronization system being configured to: search, independently from the first data storage system, BinLogs written in the storage device for a BinLog corresponding to a latest write operation, and to send the BinLog corresponding to the latest write operation to a second data storage system, so that the second data storage system synchronously updates data in the second data storage system according to the BinLog corresponding to the latest write operation.

16. The system for data synchronization according to claim 15, wherein the data synchronization system is further configured to simulate, when the data in the first data storage system is lost, the data write operation according to the BinLog written in the storage device to recover the lost data.

17. The system for data synchronization according to claim 15, wherein the first data storage system is further configured to return, after the BinLog is written to the storage device, a message indicating that the write operation is successfully performed to a computing device that performs the write operation.

18. A disaster recovery system comprising the system according to claim 15, wherein the disaster recovery system comprises the first data storage system, the data synchronization system, and the second data storage system.

19. The disaster recovery system according to claim 18, wherein the first data storage system and the data synchronization system are implemented by using a same computing device.

20. A disaster recovery system comprising multiple systems each according to claim 15, wherein:
each system comprises a data storage system and a data synchronization system,
the data storage system in a first system for data synchronization is configured to: generate, when a data write operation is performed in the data storage system, a binary log (BinLog) according to the data write operation, and write the BinLog to a storage device, and to synchronously update data in the data storage system in the first system according to a BinLog corresponding to a latest write operation while in a second system for data synchronization, a data write operation is performed in a data storage system of the second system for data synchronization, and
the data synchronization system in the first system for data synchronization is configured to: when the data write operation is performed in the data storage system, search, independently from the data storage system, BinLogs written in the storage device for the BinLog corresponding to the latest write operation, and send the BinLog corresponding to the latest write operation to a data storage system of the second system for data synchronization.
